(19) United States
(12) Patent Application Publication
(10) Pub. No.: US 2014/0353145 A1
(43) Pub. Date: Dec. 4, 2014

(54) APPARATUS FOR PRODUCING DISSOLVED HYDROGEN WATER AND PROVIDING STERILIZATION

(71) Applicant: Hyun Duk Jang, Seoul (KR)

(72) Inventor: Hyun Duk Jang, Seoul (KR)

(21) Appl. No.: 14/364,010

(22) PCT Filed: Aug. 13, 2012
(86) PCT No.: PCT/KR2012/006438

§ 371 Date: Jun. 9, 2014

(30) Foreign Application Priority Data
Aug. 10, 2012 (KR) 10-2012-0087581

(51) Int. Cl. C02F 1/461

(52) U.S. Cl. CPC C02F 1/46114; C02F 2001/4619; C02F 2201/4611; C02F 2201/46115
USPC 204/257; 204/260

(57) ABSTRACT

Apparatus for producing dissolved hydrogen water and providing sterilization is disclosed. Hydrogen radicals are dissolved in water and converted to weak alkaline hydrogen water, and particles of the water passing through media become smaller and softer in reaction to the modifying magnetic field impulse and thus can be easily absorbed to the body of a user, thereby providing dissolved hydrogen water with antioxidant effects and sterilized drinking water. A solenoid pipe is arranged outside a cartridge (10) formed into a container, a coil (20) is spirally wound on the solenoid pipe, and metal alloy media (30) fill the inside of the cartridge (10) and an internal filter (13). The cartridge (10) has an inlet (10a) and an outlet (10b). Emission and absorption of electrons between the metal media (30) and the drinking water are performed to generate active hydrogen, thus generating hydrogen water.

### TECHNICAL FIELD

The present invention relates to an apparatus for producing dissolved hydrogen water and providing sterilization wherein metal alloy mediums are filled in the inside of a cartridge with a coil spirally wound thereon, more particularly, to a invention wherein plus hydrogen molecule ions are dissolved in water and converted to weak alkaline (PH range=7.2˜8.4) hydrogen water and particles of the water passing through mediums become smaller and softer in reaction to magnetic impulse and thus can be can be easily absorbed in human body, thereby providing dissolved hydrogen water that can provide a feeling of refreshment, and germs in the water can be killed.

### BACKGROUND ART

In general, hydrogen water is known as water which eliminates harmful oxygen free radical by reducing it into water by means of a strong reducing action of active hydrogen dissolved in water and which enhances inherent level of immunity, natural healing power and vitality of the human body.

For production of such hydrogen water, a method utilizing electrolysis is mainly used, and the hydrogen water is produced by electrolysis apparatus in which, when a negative electrode and a positive electrode are arranged on both sides of a diaphragm through which ions pass and power is then applied, plus ions such as calcium, magnesium, potassium and sodium are collected on the negative electrode, whereby active hydrogen water is produced, and minus ions such as hydrochloric acid, sulfuric acid and nitric acid are collected on the positive electrode, whereby electrolyzed acid water is produced.

However, in the case where the electrolysis apparatus is used as usual, the electrolyzed acid water produced on one side of ion separation membrane is not drinkable and thus has to be thrown away. Therefore, a problem occurs that considerable amount of water is wasted.

Namely, in order to remove calcium ions or impurities attached on the electrodes during the electrolysis process, a washing process is required in which the electrodes are reversely arranged. In the washing process, 20% of the water is wasted and un-drinkable electrolyzed acid water making up 50% of the water is generated; as a result, 70% of the water is thrown away and only alkaline water (or ionic water) of about 30% is drinkable; therefore, the amount of wasted water is considerable on the whole.

In particular, the electrolysis apparatus has problems that entire structure of the apparatus is complex because the apparatus is constituted by the electrodes, ion separation membrane, various electrical devices etc. and that work of washing the electrodes has to be frequently performed.

### SUMMARY OF THE INVENTION

### Technical Problem

The invention was made in view of the above-mentioned problems, and its object is to provide an apparatus for producing dissolved hydrogen water and providing sterilization wherein no process of washing the electrodes is required due to production of hydrogen water by means of electrical current induced by impulse modification magnetic field and there is no drinkable water thrown away and various organic matters(including germs) can be oxidized and killed.

### Solution to Problem

The above-mentioned object can be achieved by an apparatus for producing dissolved hydrogen water and providing sterilization according to the present invention wherein a coil (20) is spirally wound outside a cartridge (10) constituted by a container, metal alloy mediums (30) are filled in the inside of the cartridge (10) and modification magnetic fields is formed in the metal mediums (30) when power is applied to the coil (20), an inlet (10a), and an outlet (10b) are formed at the cartridge (10) and the drinking water introduced through the inlet (10a) is discharged through the outlet (10b) after passing through the metal mediums (30) and an internal filter (13), and emission and absorption of electrons between the metal mediums (30) and the drinking water occurs to generate active hydrogen, and thus hydrogen water is produced.

### Effects of the Invention

The present invention as described above has advantages that it can provide healthful water which does not produce feelings of satiety and undulate even if the water is much drunk, by producing high-quality water that is easily absorbed in human body due to small water particle size and also provides a good feeling of refreshment, since active hydrogen is generated and dissolved in the drinking water to produce the dissolved hydrogen water when the drinking water passes through metal alloy mediums (30) inside the cartridge (10) and that the present invention can provide a device for producing dissolved hydrogen water and providing sterilization of high quality and high functionality with excellent international competitiveness which may be semi-permanently used without the conventional washing process, in which the electrodes are reversely arranged, since exchange of electrons occurs and then reduction into metal occurs again and in which the loss of water does not occur during the process of production of the hydrogen water and thus the water is not wasted at all.

### BRIEF DESCRIPTION OF THE DRAWINGS

FIG. 1 is a perspective view illustrating an embodiment of the present invention.

FIG. 2 is a sectional view illustrating the embodiment of the present invention.

FIG. 3 is an exploded perspective view illustrating a state where a cartridge of the present invention is coupled with a case.

FIG. 4 is a perspective view of a use state illustrating a state where the cartridge of the present invention is coupled with the case and a cover is opened.

FIG. 5 is an exploded perspective view illustrating a state where a spiral coil of the present invention is wound on a solenoid tube and the solenoid tube is coupled with the cartridge.

(Description of reference numerals)

| | |
|---|---|
| 1: case | 1a: catcher |
| 1b: cover | 10: cartridge |
| 10a: inlet | 10b: outlet |
| 11: connection pipe | 12: partition |
| 13: filter | 20: coil |
| 20a: solenoid tube | 21: shield cover |
| 30: medium | 40: power supply device |

### BEST MODES FOR CARRYING OUT THE INVENTION

Hereinafter, a preferred embodiment for achieving the above-mentioned object will be described in detail with reference to the attached drawings as follows.

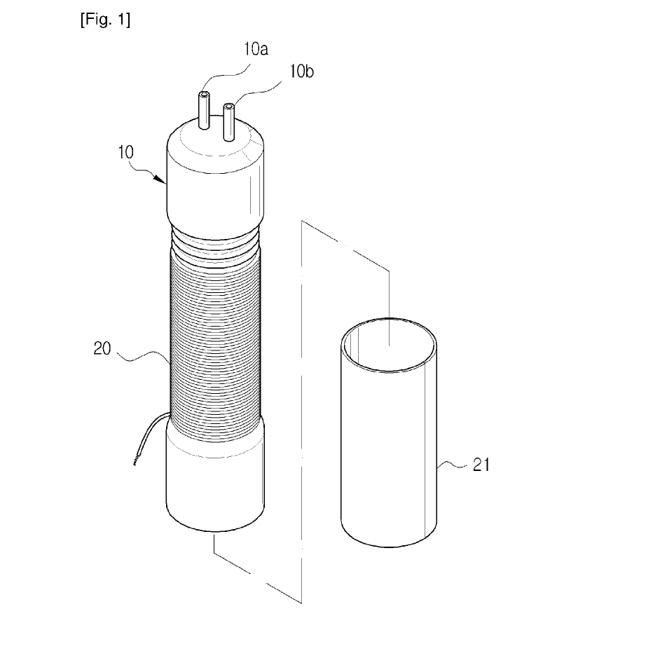

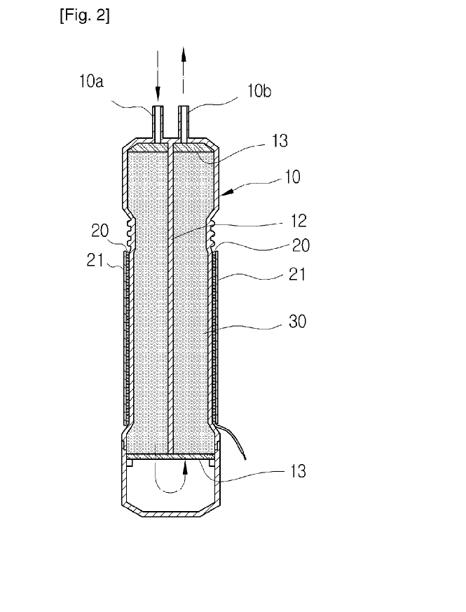

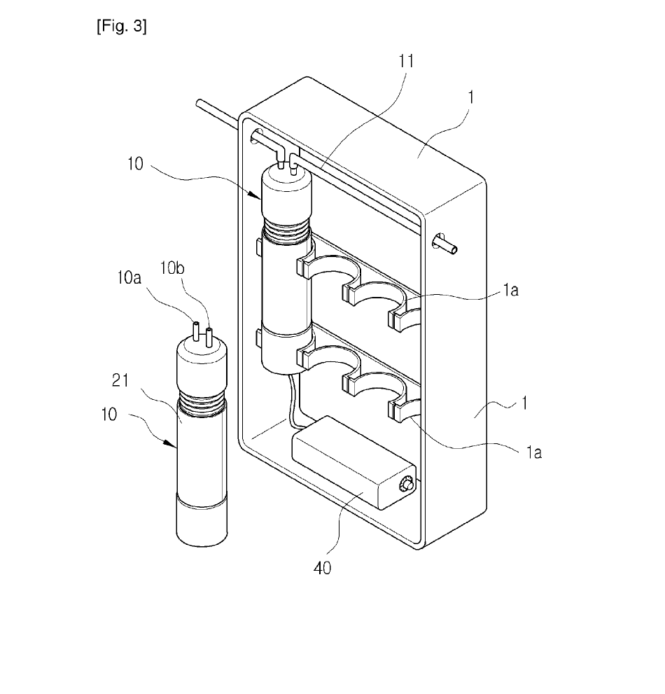

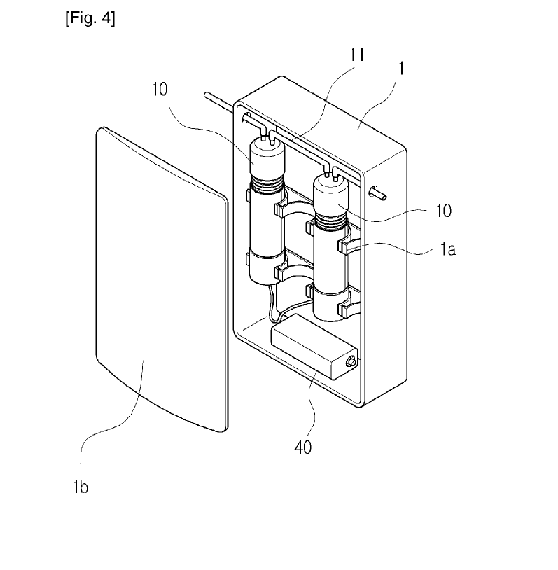

As illustrated in FIGS. 1 to 4, a coil (20) is spirally wound outside a cartridge (10) constituted by a cylindrical container, and metal alloy granules(hereinafter, referred to as “mediums”) are filled in the inside of the cartridge (10) made of synthetic resin.

Therefore, when power is applied to the coil (2) by a power supply device (40), magnetic impulse is applied to the metal alloy mediums (30), and thus active hydrogen is generated due to emission and absorption of electrons in drinking water flowing along over surfaces of the metal mediums (30).

As the metal alloy medium (30) used in the present invention, brass (Cu+Zn) is used which is composed of alloy of transition metals of zinc with higher ionization tendency and copper with lower ionization tendency, wherein Cu:Zn alloy ratio is 55:45 wt %.

An inlet (10a) and an outlet (10b) are formed at a top surface of the cartridge (10), and the drinking water introduced through the inlet (10a) is discharged through the outlet (10b).

In the present invention, a partition (12) is formed in the inside of the cartridge (10) to divide the inside into two sides. The drinking water introduced through the inlet (10a) passes through one side of the partition (12) and thereafter makes a U-turn and then is discharged through the outlet (10b) on the other side of the partition (12).

Non-woven fabric filters (13) are inserted on a top side and a bottom side of the inside of the cartridge (10). The non-woven fabric filters (13) are used to prevent escape of the metal mediums (30) and filter out solid matter or organic matter precipitated from the drinking water.

While passing between the metal mediums (30), the drinking water introduced through the inlet (10a) makes a bond with electrons emitted from the mediums by the applied magnetic impulse to generate active hydrogen, and bond of hydrogen atoms results in formation of hydrogen molecules, which are dissolved in the drinking water to produce dissolved hydrogen water.

At this time, in the drinking water, molecule of the water is present as hydroxyl group ion and hydrogen ion as seen in the following reaction formula: H₂O [symbol] H⁺+OH⁻, and when electrical current induced by the modification magnetic field flows in the metal mediums (30), zinc(Zn) with a higher ionization tendency than hydrogen is firstly ionized with reaction with the magnetic impulse and reacts with hydrogen ion (H⁺) to give electrons to the hydrogen (H⁺), whereby hydrogen molecule is generated as seen in the following reaction formula: Zn+2H⁺→Zn⁺⁺+H₂↑ and is present in the drinking water.

Furthermore, the copper (Cu²⁺) moves free electrons while being converted into copper ion (Cu^{N+}) by magnetic impulse energy, and the zinc (Zn⁺⁺) in the alloy that has lost electrons receives electrons emitted from the copper to be reduced into metal zinc (Zn⁺⁺+2e⁻→Zn), and thus is conserved with its mass as it is without loss.

Furthermore, the copper (Cu^{N+}) forcibly takes electrons from external substances (for example, OH⁻, Cl⁻, H₂) due to reducing nature inherent in the copper to be reduced into metal copper (Cu). At this time, when electron is taken out from the hydroxyl group ion (OH⁻) of the external substances, the hydroxyl group ion (OH⁻) becomes hydroxyl radical (OH^{*}) and thus performs sterilizing function with a strong oxidizing power, and when electron is taken out from the chlorine ion (Cl⁻), the chlorine ion becomes chloride which is harmless substance, and when electron is taken out from the hydrogen molecule (H₂), the hydrogen molecule becomes plus hydrogen molecule ion (H₂⁺), which is dissolved in the water to produce the dissolved hydrogen water.

Therefore, conventional washing process where electrodes are reversely arranged is not required and thus may be used semi-permanently, and no loss of water occurs and the whole drinking water may be used.

The apparatus for producing hydrogen water and providing sterilization of the present invention artificially breaks bond of water particles(hereinafter, referred to as clusters) and then allows the clusters to become hexagonal water again, when the drinking water passes through the mediums (30); therefore, the drinking water can be smoothly swallowed. The plus hydrogen molecule ion (H₂⁺) generated at this time is dissolved in the water, whereby healthful water may be produced which eliminates oxygen free radical that is a major cause of aging.

Furthermore, although the oxygen free radical generated along with the active hydrogen is present as free radical having a short life, the oxygen free radical momentarily becomes water again when meeting the active hydrogen (OH^{*}+H^{*}═H₂O) and is stabilized.

The hydroxyl radical, which is one of the oxygen free radicals (OH⁻−e⁻→OH^{*}) generated by emission of the electron from hydroxyl group, has a strong oxidizing power that is about 1,000 times that of the chlorine, and thus oxidizes various organic matter (including germs) into gas (CO₂, NO₂), thereby purifying the drinking water into clean water. Therefore, the apparatus for producing hydrogen water according to the present invention may be also used for a sterilizing water purifier.

Meanwhile, the power supply device (40) provides the spiral coil (20) with electrical energy, adjusts a level of applied electrical current by duty cycle of pulse depending on a condition of the drinking water, and produce optimized water by controlling frequency of pulse waveform to adjust the quantity of hydrogen generated.

The present invention constituted as described above can provide healthful water which does not produce feelings of satiety and undulate even if the water is much drunk, by producing high-quality water that is easily absorbed in human body due to small water particle size and also provides a good feeling of refreshment, since active hydrogen is generated and dissolved in the drinking water to produce the dissolved hydrogen water when the drinking water passes through mediums (30). Furthermore, the present invention can provide a device for producing dissolved hydrogen water and providing sterilization that may be semi-permanently used without the conventional washing process, in which the electrodes are reversely arranged, since exchange of electrons occurs and then reduction into metal occurs again, and the present invention can prevent the water from being lost during the process of production of the hydrogen water.

Furthermore, the water passing through the modification magnetic field is magnetized and thus the cluster formed by collected water molecules produces the hexagonal water with hexagonal ring shape. Therefore, the cluster is small, so that water with small clusters can be provided which healthy cells like, and an effect can be obtained that germs in the water are killed with the strong oxidizing power of the hydroxyl radical(OH*) which is one of oxygen free radical species that are momentarily generated and then disappear. Thus, there is an advantage that an apparatus for producing dissolved hydrogen water and providing sterilization having excellent international competitiveness can be provided.

Meanwhile, a shield cover (21) formed by a metal cylinder is arranged outside the spirally wound coil (20). The shield cover (21) serves to protect the spiral coil, shield energy lost in leakage of the magnetic field, thereby preventing EMI(Electro Magnetic Interference) and maximize the intensity of the modification magnetic field inside a solenoid tube.

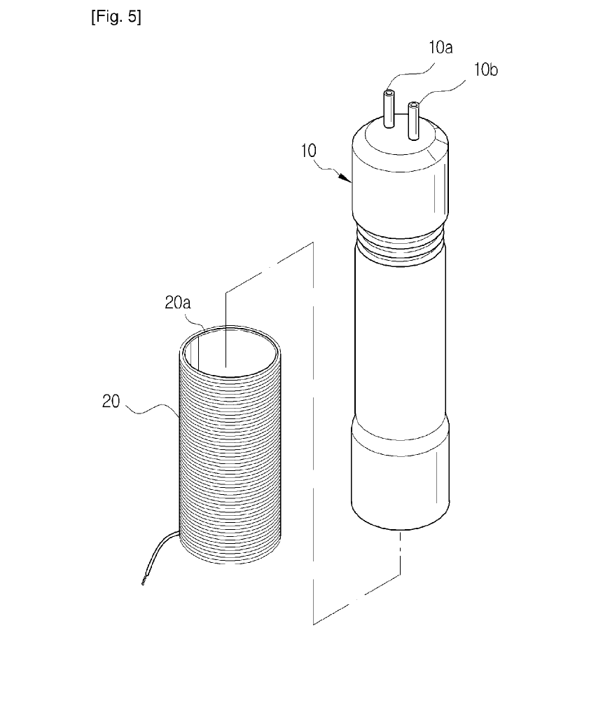

Preferably, as illustrated in FIG. 5, in a case where the spiral coil (20) according to the present invention is wound on the solenoid tube (20a) and the solenoid tube (20a) is coupled with the cartridge (10), work of winding the coil (20) is convenient and the solenoid tube (20a) can be easily coupled with the cartridge (10), whereby convenience of the work and productivity can be increased.

The cartridge (10) is coupled with internal catchers (1a) of a case (1), and efficiency of production of the dissolved hydrogen water can be maximized by connecting two to four cartridges (10) by connection pipes (11) and thus allowing the drinking water to be continuously treated. The cartridge (10) detachably coupled with the catchers (1a) can be easily changed.

In the drawings, reference numeral “1b” not described designates a cover that is coupled with the front of the case (1).

While, as above, preferred embodiment of the present invention has been illustrated and described, the present invention is not limited to the embodiment described above, and it is obvious to those skilled in the art that various modifications may be made without departing from the gist defined in the appended claims, and the claims cover such modifications.

1. An apparatus for producing dissolved hydrogen water and providing sterilization, wherein a coil (20) is spirally wound outside a cartridge (10) constituted by a container, metal alloy mediums (30) are filled in the inside of the cartridge (10) and modification magnetic fields is formed in the metal mediums (30) when power is applied to the coil (20), an inlet (10a), and an outlet (10b) are formed at the cartridge (10) and the drinking water introduced through the inlet (10a) is discharged through the outlet (10b) after passing through the metal mediums (30) and an internal filter (13), and emission and absorption of electrons between the metal mediums (30) and the drinking water occurs to generate active hydrogen, and thus hydrogen water is produced.

2. The apparatus for producing dissolved hydrogen water and providing sterilization according to claim 1, wherein a partition (12) is formed in the inside of the cartridge (10) to divide the inside into two sides, and the drinking water introduced through the inlet (10a) passes through one side of the partition (12) and thereafter makes a U-turn and then is discharged through the outlet (10b) on the other side of the partition (12).

3. The apparatus for producing dissolved hydrogen water and providing sterilization according to claim 1, wherein a shield cover (21) constituted by a metal cylinder is arranged outside the spirally wound coil (20), and the cartridge (10) is coupled with internal catchers (1a) of a case (1), and two to four cartridges (10) are connected by connection pipes (11) to enable the drinking water to be continuously treated.

4. The apparatus for producing dissolved hydrogen water and providing sterilization according to claim 1, wherein the spiral coil (20) is wound on a solenoid tube (20a) and the solenoid tube (20a) is coupled with the cartridge (10).
